(19) United States
(12) Patent Application Publication
(10) Pub. No.: US 2007/0064435 A1
(43) Pub. Date: Mar. 22, 2007

(54) Mirror housing

(76) Inventors: Klaus Weller, Ebersbach (DE); Karl-Heinz Leonberger, Hochdorf (DE)

Correspondence Address: CLARK HILL, P.C., 500 WOODWARD AVENUE, SUITE 3500, DETROIT, MI, 48226, US

(21) Appl. No.: 11/372,536

(22) Filed: Mar. 10, 2006

(30) Foreign Application Priority Data
Mar. 10, 2005 (DE) DE10 2005012104.7

(51) Int. Cl. B60R 1/12; B60Q 1/26

(52) U.S. Cl. 362/494

(57) ABSTRACT

A mirror housing includes a front side that defines a mirror opening and a rear side that defines a housing contour. The rear side includes a recess extending along a portion of the rear side. The rear side and the recess are unitary in structure. A light plate extends across the recess. The light plate has a contour that is substantially similar to the housing contour. The light plate is welded to the recess along a shoulder face thereof permanently sealing the space between the recess and the light plate and eliminating the need for a seal between the space and the mirror housing.

### BACKGROUND ART

1. Field of the Invention

The invention relates to a mirror housing. More particularly, the invention relates to a mirror housing with a light fastened thereto.

2. Description of the Related Art

Rear view side mirrors are known in whose mirror head a repeating blinking light is housed as a lighting unit. The light housing for these repeating blinking lights is relatively expensive to mount with the mirror housing since a faultless seal between these parts is necessary.

### SUMMARY OF THE INVENTION

In the housing according to the invention the light housing is connected as one piece to the housing. Thereby both parts can be made together so that a separate mounting of the light housing on the housing is omitted. Through the single-piece connection a tight connection between these housings is achieved as well, which also has an economical effect on the production of the housing.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is a rear perspective view an outer rear view side mirror with a repeating blinking light which is housed in a housing according to the invention;

FIG. 2 is a cross-sectional view taken along the lines 2-2 of FIG. 1;

FIG. 3 is a fragmentary cross-sectional view of the light housing according to the invention in a simplified and enlarged representation;

FIG. 4 is a fragmentary cross-sectional view of an alternative embodiment of the light housing according to the invention.

### DETAILED DESCRIPTION OF THE PREFERRED EMBODIMENTS

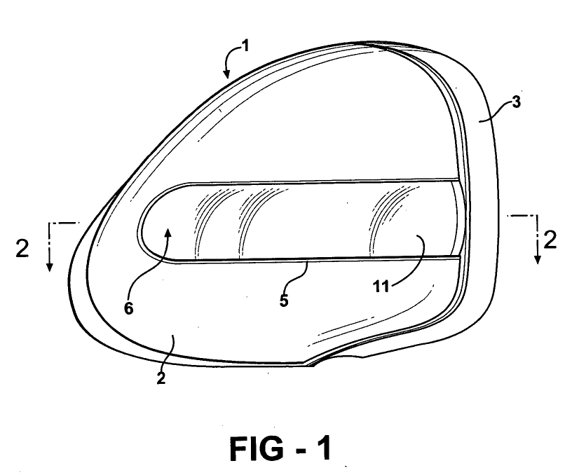

Referring to FIGS. 1 through 3, the outer rear view side mirror has a mirror head 1 with a mirror housing 2. The mirror housing 2 is disposed on a mirror foot 3 in such a manner that it can be folded out in a known manner in and opposite to the direction of travel. The mirror housing 2 consists of plastic.

A mirror glass support with mirror glass is housed in the housing 2. Pointing forward in the direction of travel, a rear side 4 of the mirror housing 2 has a receiving space 5 for a lighting unit 6 formed as a blinking light.

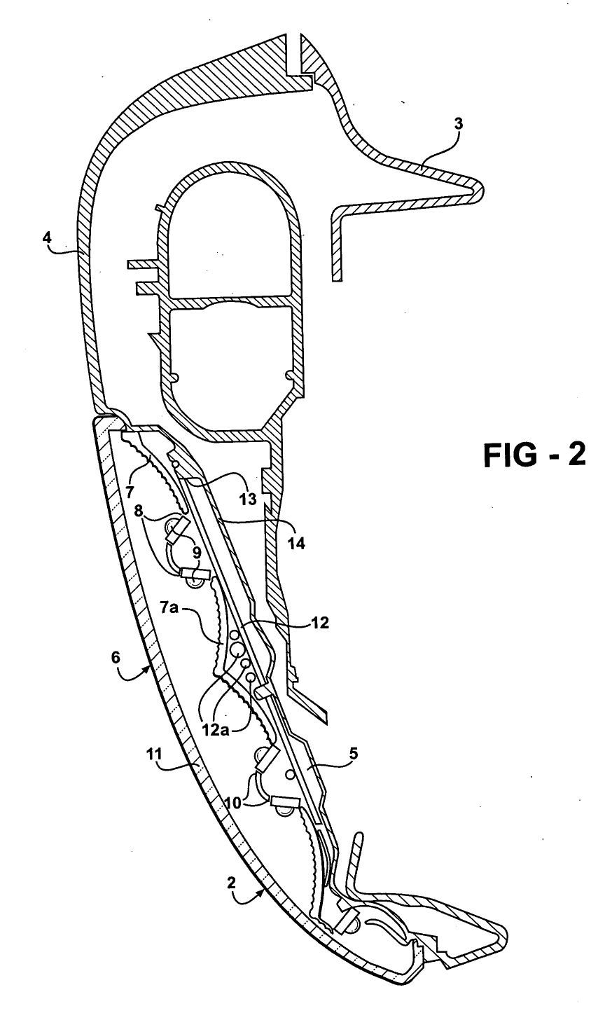

The receiving space 5 is a recess formed in the rear side 4 (FIGS. 2 through 4). In the receiving space 5 a reflector 7 is housed which includes openings 8 into which a light source 9, preferably LEDs, project. The openings 8 are provided in oblique wall sections 10 of the reflector 7. In the embodiment shown in the Figures, neighboring wall sections 10 lie on opposite sides of a V-shaped portion 7a of the reflector 7. The receiving space 5 is closed by a light plate 11 through which the light emitted by the light source 9 exits to the outside. On a side of the reflector 7, specifically the side facing away from the light plate 11, a circuit board 12 is provided on which the electrical/electronic components 12a for the power supply of the lighting means 9 sit. The circuit board 12 lies with its edge on a supporting face 13 at the base 14 of the receiving space 5.

The reflector 7 can be fastened in the receiving space 5 in any suitable manner. The light sources 9 are disposed so that one part of the light emitted by them arrives directly at the light plate 11 and one part is reflected by the reflector 7 toward the light plate 11, and subsequently through the light plate 11.

The light plate 11 seals the receiving space 5 tight. An outer side 15 of the light plate 11 forms at least approximately a continuation of the outer side 16 of the rear side 4 of the mirror housing 2. More specifically, the outer side 15 of the light plate 11 approximates the contour of the outer side 16 of the rear side 4 of the mirror housing 2.

The light plate 11 has an encircling angled edge 17 having a face side 18. A narrow stud 19 extends out from the center of the face side 18. With it, the light plate 11 is mounted on a shoulder face 20, which is set back with respect to the outer side 16 of the rear side 4. The shoulder face 20 creates a relief with respect to the outer side 16 of the rear side 4. The shoulder face 20 connects transversely to a side wall 21 of the receiving space 5 and is connected to the rear side 4 via a narrow edge 22 running transverse to the shoulder face 20. The rear side 4, the faces 20, 22, and the side wall 21 are formed as a unitary structure.

The stud 19 is connected to the shoulder face 20 using a welding procedure. Thereby a faultless, fixed, and tight connection between the light plate 11 and the shoulder face 20 results. Advantageously, in the shoulder face 20 a flat groove 23 is provided into which the stud 19 engages on mounting of the light plate 11. For the following welding process, an optimal positioning and a faultless tight connection is achieved thereby.

Between the edge 17 of the light plate 11 and the edge 22 a narrow gap 24 is provided. It can be held to a constant width in a simple manner as a consequence of the groove 23.

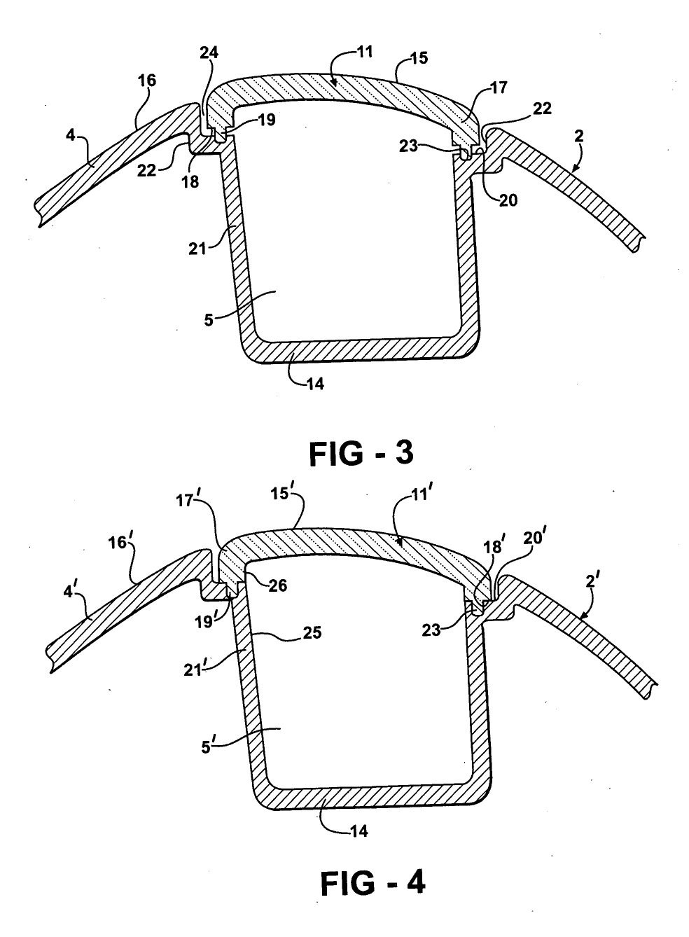

In the embodiment according to FIG. 4, wherein like primed numerals represent similar elements as those discussed above in the first embodiment, the shoulder face 20′ is significantly thicker than in the preceding embodiment. The stud 19′ is longer than in the preceding embodiment. Accordingly, the groove 23′ extends deeper into the shoulder face 20′ than in the first embodiment according to FIG. 3. If the light plate 11′ is connected to the mirror housing 2′ in such a manner that it is fixed, then the light plate 11′ lies with its face side 18′ on the shoulder face 20′, in contradistinction to the previous embodiment.

The stud 19′ is held in the groove 23′ by an adhesive connection. Since the groove 23′ is sufficiently deep and the stud 19′ is sufficiently long, a large adhesive surface is available. Advantageously the length of the stud 19′ corresponds to the depth of the groove 23′.

The light plate 11′ is glued tightly so that an inner side 25 of the side wall 21′ of the receiving space 5′ forms a continuous extension of an inner side 26 of the edge 17′ of the light plate 11′. In other respects the embodiment is formed the same as the first embodiment according to FIG. 3.

The light plate 11 can have any suitable form in outline. If the light plate 11 is connected by plastic welding (FIG. 3) to the mirror housing 2, the light plate 11 and the mirror housing 2 consist of plastics which can be compatibly welded to one another.

The components of the lighting unit 6 can be disposed, formed, and mounted in any manner. In the mirror housing 2, in addition to the lighting unit 6, still other elements can be housed, such as a camera module, an ambient lighting unit, an antenna, a heating element for the mirror glass, a GPS module, sensors for automatic dimming the mirror glass, and the like.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

1-14. (canceled)

15. A mirror housing having a front side defining a mirror opening and a rear side defining a housing contour, said rear side including a recess extending along a portion of said rear side wherein said rear side and said recess are unitary in structure.

16. A mirror housing as set forth in claim 15 wherein said recess includes a relief extending thereabout.

17. A mirror housing as set forth in claim 16 wherein said relief defines a perimeter.

18. A mirror housing as set forth in claim 17 wherein said relief includes a shoulder face extending about said recess along said perimeter.

19. A mirror housing as set forth in claim 18 wherein said shoulder face defines a groove cut into said shoulder face.

20. A mirror housing as set forth in claim 19 including a light plate extending across said recess having a light plate contour substantially similar to said housing contour.

21. A mirror housing as set forth in claim 20 wherein said light plate defines an angled edge.

22. A mirror housing as set forth in claim 21 wherein said angled edge defines a face side at a distal end thereof.

23. A mirror housing as set forth in claim 22 wherein said face side includes a stud extending out therefrom.

24. A mirror housing as set forth in claim 23 wherein said stud is receivable by said groove when said light plate is fixedly secured to said mirror housing.

25. A mirror comprising:
a mirror housing including a front side defining a mirror opening and a rear side defining a housing contour, said rear side including a recess extending along a portion of said rear side wherein said rear side and said recess are unitary in structure; and
a light plate extending across said recess having a light plate contour substantially similar to said housing contour.

26. A mirror housing as set forth in claim 25 wherein said recess includes a relief extending thereabout.

27. A mirror housing as set forth in claim 26 wherein said relief defines a perimeter.

28. A mirror housing as set forth in claim 27 wherein said relief includes a shoulder face extending about said recess along said perimeter.

29. A mirror housing as set forth in claim 28 wherein said shoulder face defines a groove cut into said shoulder face.
